(19) United States
(12) Patent Application Publication
(10) Pub. No.: US 2008/0094509 A1
(43) Pub. Date: Apr. 24, 2008

(54) APPARATUS FOR PROVIDING MULTIPLE SCREENS AND METHOD OF DYNAMICALLY CONFIGURING MULTIPLE SCREENS

(75) Inventors: Jong-ho LEE, Seoul (KR); Kwang-kee Lee, Seoul (KR); Sung-wook Byun, Suwon-si (KR); Glenn A. Adams, Acton, MA (US); Un-gyo Jung, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/957,823

(22) Filed: Dec. 17, 2007

Related U.S. Application Data
(63) Continuation-in-part of application No. 11/496,403, filed on Aug. 1, 2006.
(60) Provisional application No. 60/705,491, filed on Aug. 5, 2005.
(60) Provisional application No. 60/789,577, filed on Apr. 6, 2006.
(60) Provisional application No. 60/812,090, filed on Jun. 9, 2006.
(60) Provisional application No. 60/870,471, filed on Dec. 18, 2006.
(60) Provisional application No. 60/918,894, filed on Mar. 20, 2007.

(30) Foreign Application Priority Data
Apr. 4, 2007 (KR) 10-2007-0033497

(51) Int. Cl. H04N 5/445

(52) U.S. Cl. 348/564

(57) ABSTRACT

An apparatus and method for providing multiple screens are provided. The apparatus includes a digital signal processing module which confirms whether a focus request regarding a first region on a screen has been issued, and an operational module which operates the application on the screen based on the confirmed result, wherein the first region displays an application included in received data information.

### CROSS-REFERENCE TO RELATED APPLICATIONS

This application is a continuation-in part of U.S. patent application Ser. No. 11/496,403 filed on Aug. 1, 2006, which claims priority from U.S. Provisional Patent Application No. 60/705,491 filed on Aug. 5, 2005, U.S. Provisional Patent Application No. 60/789,577 filed on Apr. 6, 2006, and U.S. Provisional Patent Application No. 60/812,090 filed on Jun. 9, 2006, the disclosures of which are incorporated herein by reference in their entirety. This application also claims priority from U.S. Provisional Patent Application No. 60/870,471 filed on Dec. 18, 2006, U.S. Provisional Patent Application No. 60/918,894 filed on Mar. 20, 2007, and Korean Patent Application No. 2007-0033497 filed on Apr. 4, 2007, the disclosure of which are incorporated herein by reference in their entirety.

### BACKGROUND OF THE INVENTION

1. Field of the Invention

Apparatuses and methods consistent with the present invention relates to providing and dynamically configuring multiple screens, and more particularly, to providing multiple screens using flags included transferred packets in order to dynamically configure the multiple screens that provide a plurality of contents on a physical display device.

2. Description of the Related Art

Related art broadcast receivers such as digital TVs or digital set-top boxes provide only one content element on a single physical display device or simultaneously display a main screen and a sub-screen on a single physical display device.

Even though related art broadcast receivers can simultaneously display both the main screen and the sub-screen on the same display screen, they can only arrange the main screen and the sub-screen in a limited number of manners. In the case of a content displayed within the main screen, all elements of the content, i.e., video data, audio data, and other data, are displayed. On the other hand, in the case of a content displayed within the sub-screen, only some of the elements of the content are displayed.

Content sources include a broadcast service such as a satellite broadcaster, a terrestrial broadcaster, or a cable broadcaster, a storage medium such as digital versatile discs (DVDs), or an external device connected to an input terminal. However, it is quite difficult to display contents provided by such various content sources on a display screen using the existing broadcast receivers.

In an interactive TV application program environment such as the Multimedia Home Platform (MHP), the Advanced Common Application (ACAP), and the Open Cable Application Platform (OCAP), it is assumed that only one screen is output on a physical display device.

In the interactive TV application program environment, for example, a Home Audio/Video Interoperability (HAVi)-based user interface (UI) is adopted. According to the HAVi UI standard, even though no restriction is imposed on the number of screens displayed on a physical display device, only one screen is generally displayed on a physical display device.

In such an environment, it is difficult to perform operations, such as decoding, digital signal processing, user interaction processing, etc. with respect to one among multimedia contents displayed on a screen while displaying the multimedia contents on independent screens. In addition, it is also difficult to dynamically control the life cycles of application programs and the use of resources in the units of the screens.

Accordingly, there exists a need for a method of displaying a variety of contents on a dynamically configured screen.

### SUMMARY OF THE INVENTION

The present invention provides an apparatus and method for dynamically configuring multiple screens which provide a plurality of contents on a physical display device.

According to an aspect of the present invention, there is provided an apparatus for providing multiple screens, the apparatus including a digital signal processing module which confirms whether a focus request regarding a first region on a screen that has been issued; and an operational module which operates the application on the screen on the basis of the confirmed result, wherein the first region displays an application included in received data information.

According to another aspect of the present invention, there is provided a method of providing multiple screens, the method including confirming whether a focus request regarding a first region on a screen has been issued; and operating the application on the screen on the basis of the confirmed result, wherein the first region displays an application included in received data information.

### BRIEF DESCRIPTION OF THE DRAWINGS

The above and other aspects of the present invention will become more apparent by describing in detail exemplary embodiments thereof with reference to the attached drawings in which:

FIGS. 1 to 8 are diagrams illustrating configurations of PiP screens according to an exemplary embodiment of the present invention;

FIG. 9 is a diagram illustrating the relationship between a logical screen and a display screen according to an exemplary embodiment of the present invention;

FIG. 10 is a diagram illustrating a source that provides services, according to an exemplary embodiment of the present invention;

FIGS. 11 to 12 are diagrams illustrating a non-abstract service and an abstract service according to an exemplary embodiment of the present invention;

FIG. 13 is a diagram illustrating a method of mapping two services on a display screen according to an exemplary embodiment of the present invention;

FIG. 14 is a diagram illustrating application regions according to an exemplary embodiment of the present invention;

FIG. 15 is a diagram illustrating a configuration of system providing multiple screens according to an exemplary embodiment of this invention;

FIG. 16 is a block diagram of an apparatus for providing multiple screens according to an exemplary embodiment of the present invention;

FIG. 17 is a flowchart illustrating a method of dynamically configuring multiple screens according to an exemplary embodiment of the present invention; and

FIG. 18 is a flowchart illustrating the focus of an application region according to an exemplary embodiment of the present invention.

### DETAILED DESCRIPTION OF EXEMPLARY EMBODIMENTS OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention is described hereinafter with reference to flowchart illustrations of user interfaces, methods, and computer program products according to embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks illustrated in succession may in fact be executed substantially concurrently or the blocks may sometimes be executed in the reverse order, depending upon the functionality involved.

For a better understanding of the present invention, the terms used in this disclosure will now be defined.

The term ‘service’ indicates a group of multimedia contents displayed together, i.e., a group of service components.

Service components are elements of a service and include a video component, an audio component, and a data component. A data component is an application program in a service.

The term ‘service context’ indicates an object which can control the executing of a service and includes various resources information, device information, and execution state information needed for providing a service.

The term ‘physical display device’ indicates a physical space which actually displays the content of a service.

The term ‘display screen’ indicates a screen actually displayed on a physical display device. An arbitrary service may be directly set in the display screen, and the display screen may be displayed on a physical display device. Alternatively, at least one logical screen which is mapped to a certain area of the display screen may be displayed on the physical display device.

The term ‘logical screen’ indicates a space in which an arbitrary service is displayed. A logical screen is a virtual screen before being mapped to a display screen and thus is not displayed on a physical display device.

The logical screen and the display screen may be a combination of a background still image, a video raster, and a graphic raster. The graphic raster may be a combination of text, lines, colors, and images or a mixture of video frames.

The term ‘main service’ indicates a service that is selected as a main service through a menu displayed on the physical display device or a remote controller by a user or through an application programming interface (API) by an application, and the screen on which the main service is displayed is referred to as a ‘main screen’.

The term ‘Picture-in-Picture service’ (PiP service) indicates a service that is selected as a sub-service in the main service through a menu displayed on a physical display device or a remote controller by a user or via an API by an application, and the Pip service may be displayed on a picture-in-picture screen (PiP screen) or a main screen.

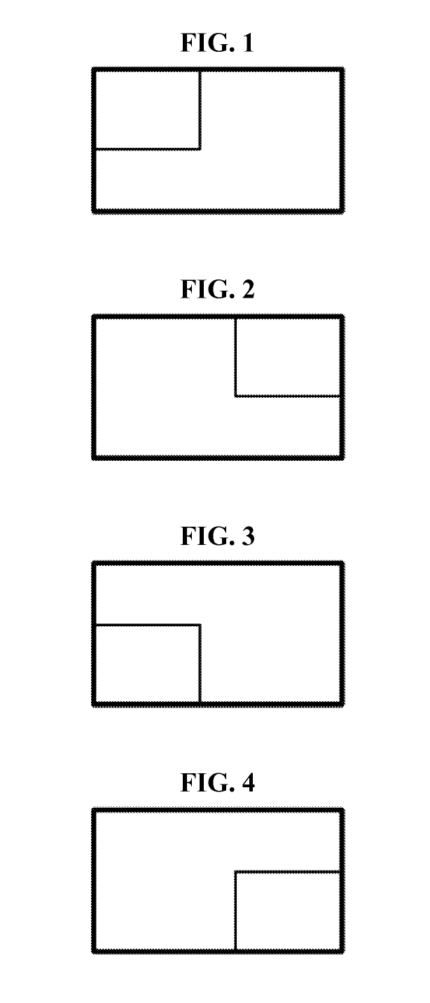

It can be understood that the PiP screen includes: a screen that occupies a portion of another screen, as illustrated in FIGS. 1 to 4; two screens that are displayed in an area, and do not overlap each other, as illustrated in FIGS. 5 and 6; and a screen that overlaps another screen, as illustrated in FIGS. 7 and 8.

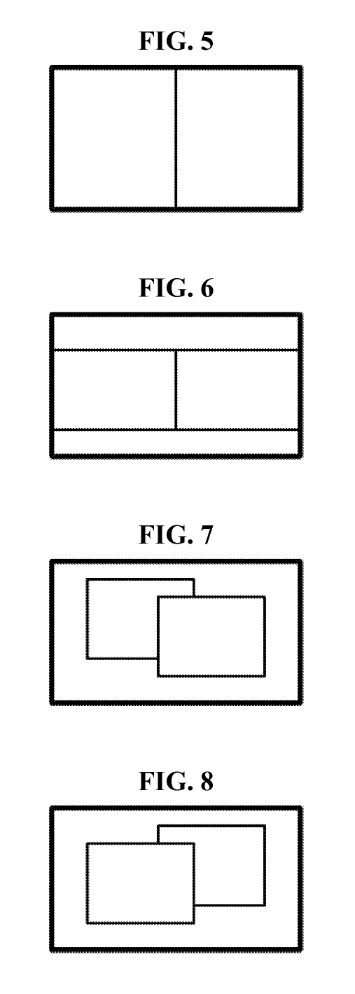

FIG. 9 is a diagram illustrating the relationship between a logical screen and a display screen according to an exemplary embodiment of the present invention.

Referring to FIG. 9, a service may be displayed using logical screens 210, 212, and 214. The logical screens 210, 212, and 214 are mapped to display screens 220, 222, and 224 through a mapping block 230.

In detail, the logical screens 210 and 212 are mapped to the display screen 220, the logical screens 212 and 214 are mapped to the display screen 222, and the logical screens 210, 212, and 214 are mapped to the display screen 224.

In short, at least one logical screen which displays a service is mapped to an arbitrary area of a display screen by the mapping block 230.

The mapping block 230 is a group of various pieces of information needed for mapping a logical screen to a display screen. Examples of the various pieces of information include coordinate information of a predetermined area on a display screen to which each of a plurality of logical screens is mapped, identification information of the logical screens and the display screen, and information specifying in what order the logical screens are displayed on the display screen. The mapping block 230 may be realized by interfaces or functions prepared by various computer program languages to be executed and create or change the relationship between the logical screen and the display screen by using the above information as parameters.

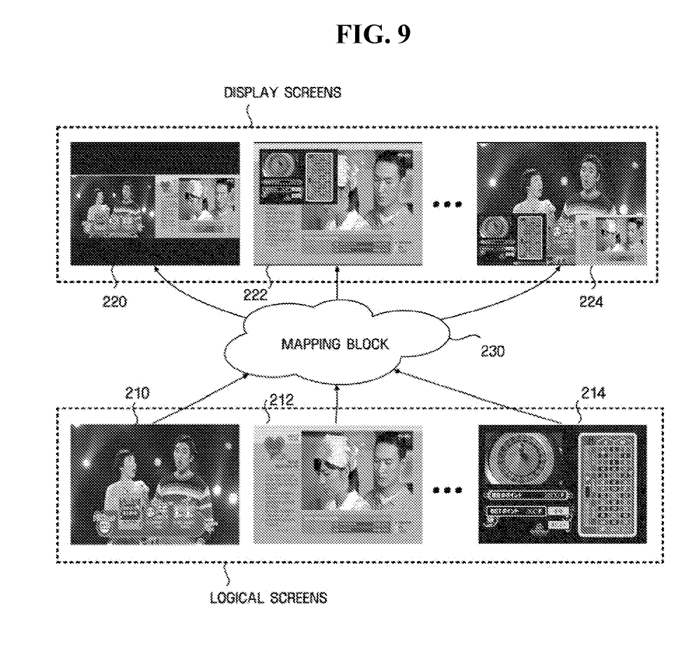

Further, services provided by various service sources may be displayed on a display screen, and the display screen may be displayed on a physical display device, as illustrated in FIG. 10.

There are service sources which provide broadcast services such as a terrestrial broadcaster 320 and a cable broadcaster 330, service sources which provide services stored in a storage medium such as a personal video recorder (PVR) 340, and service sources (not illustrated in FIG. 10) which provide services via a wired network or a wireless network.

A broadcast receiver 310 receives services from the service sources and produces logical screens displaying each of the received services.

Then, an arbitrary service is directly set on the display screen to be displayed on a physical display device using a predefined method or a method set by a user or an application. Otherwise, at least one logical screen that is mapped to an arbitrary area on the display screen is displayed on a physical display device 350. In short, services provided by the terrestrial broadcaster 320, the cable broadcaster 330, and the PVR are displayed on the physical display device 350.

The terrestrial broadcaster 320, the cable broadcaster 330, and the PVR 340 are illustrated in FIG. 10 as being service sources, but the present invention is not limited to it. Any type of multimedia content source which provides multimedia contents that can be displayed together can be a service source according to an exemplary embodiment of the present invention.

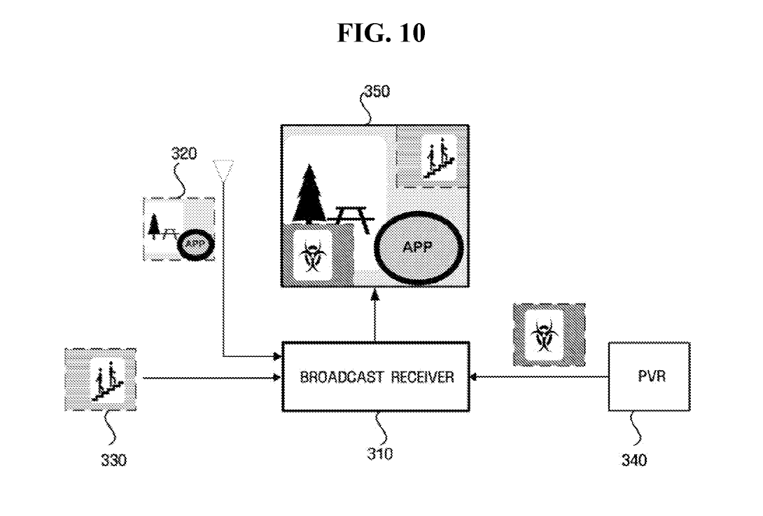

Services according to an exemplary embodiment of the present invention can be classified into abstract services and non-abstract services, as illustrated in FIGS. 11 and 12.

The abstract services are not services provided by broadcast signals transmitted in real time but services independent of broadcast channels. The abstract services include only data components, i.e., application programs, without video components and audio components. Examples of the abstract services include services having unbound applications based on the OCAP standard.

The non-abstract services are understood as services other than abstract services.

According to the current exemplary embodiment of the present invention, both abstract services and non-abstract services have independency. For example, abstract services may be directly set on the physical display device not through logical screens and non-abstract services may be displayed on the logical screens. Then, the logical screens may be mapped to the display screen in which the abstract services are set. Thereafter, the display screen may be output through the physical display device. By doing so, the abstract services can be displayed on the display screen independently of the non-abstract services. In addition, the abstract services and non-abstract services may be mapped to different logical screens. Thereafter, the logical screens may be mapped to a single display screen. In other words, the abstract services can be displayed on the display screen independently of non-abstract services.

According to the current exemplary embodiment of the present invention, the logical screen and the display screen may be categorized as being different objects. Alternatively, a screen may serve as a logic screen or a display screen according to attribute information of one screen object.

In detail, if screen object attributes corresponding to the characteristics of a logical screen has a predefined value and other screen object attributes have fixed values, a screen object may serve as a logical screen. On the other hand, if screen object attributes corresponding to the characteristics of a display screen have predefined values and other screen object attributes have fixed values, a screen object may serve as a display screen.

Further, the applications include an unbound application and a service bound application. Since the unbound application has a high priority, the resource therefor is smoothly allocated. A monitor application corresponds to a specific unbound application that has the highest priority.

The service bound application is associated to a transport stream, and allows a lower priority than that of the unbound application. The service bound application does not function as a critical system. When a competition for resources is occurred, the service bound application has a larger possibility of abandoning the resource allocation than the unbound application.

Application that is driven in an OCAP-based terminal or a set-top box includes an electronic program guide (EPG), video on demand (VOD), an application XYZ, a native application, etc.

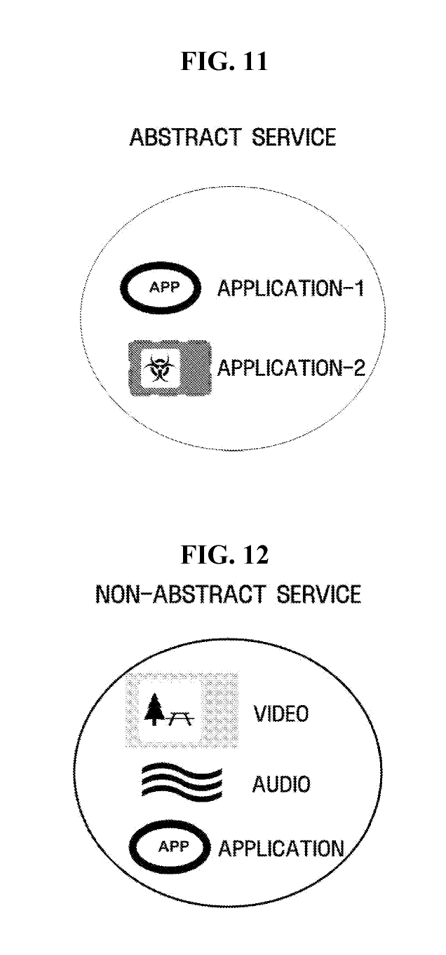

FIG. 13 is a diagram illustrating a process that two services are set on a display screen to be mapped to a single display screen.

Referring to FIG. 13, a first service includes all the three service components, i.e., video, audio, and data components, and a second service includes only video and audio components. However, the present invention does not impose any restrictions on service components, and the first and second services illustrated in FIG. 13 are exemplary.

As illustrated in FIG. 13, the first and second services are displayed on a physical display device in almost the same manner as in the related art. According to the current exemplary embodiment of the present invention, it is possible to display a plurality of services on a physical display device independently of one another without imposing any restrictions on the number of services that can be displayed on a single display screen.

On the other hand, a data component includes application information regarding the application for the service, and the application information includes signal information indicating whether the application can be executed on the PiP screen. Examples of the application information include an application information table (AIT) based on the MHP standard and an eXtended application information table (XAIT) based on the OCAP standard. The signal information may be added to the application information.

According to the DVD-MHP standard, an application is subordinated to a service, and the lifecycle of the application is determined on the basis of a currently selected service. On the contrary, an application according to the OCAP standard is not subordinated to a service, and the lifecycle is further independent of the signal information.

Examples of the application include an application by host device manufacturer, an application that is signaled through an XAIT, and an application registered through a monitor application.

The OCAP terminal can manage the lifecycle of the bound or unbound application by receiving the signal. Various types of signaling for executing the service bound and unbound applications are supported on the basis of the OCAP standard. Contents of an application database are created or renewed as a result of the signaling. The application database is a collective name of data that is managed by an application manager, and the application manager manages the lifecycle of the application using an application lifecycle API.

There are three types of application signaling, one is for service bound application and the others are for unbound application.

As described above, the signaling can be used to notify to the OCAP terminal whether the multi-screens are supported. In detail, a broadcaster 600 provides an application to the OCAP terminal and notifies whether the currently provided application supports the multi-screens, by means of a signal. Therefore, the OCAP terminal can determine whether the currently provided application can be utilized, using the received signal. For example, it is possible to provide functions such as a screen size, screen position, pause, etc. to a user while providing the application on the logical screen.

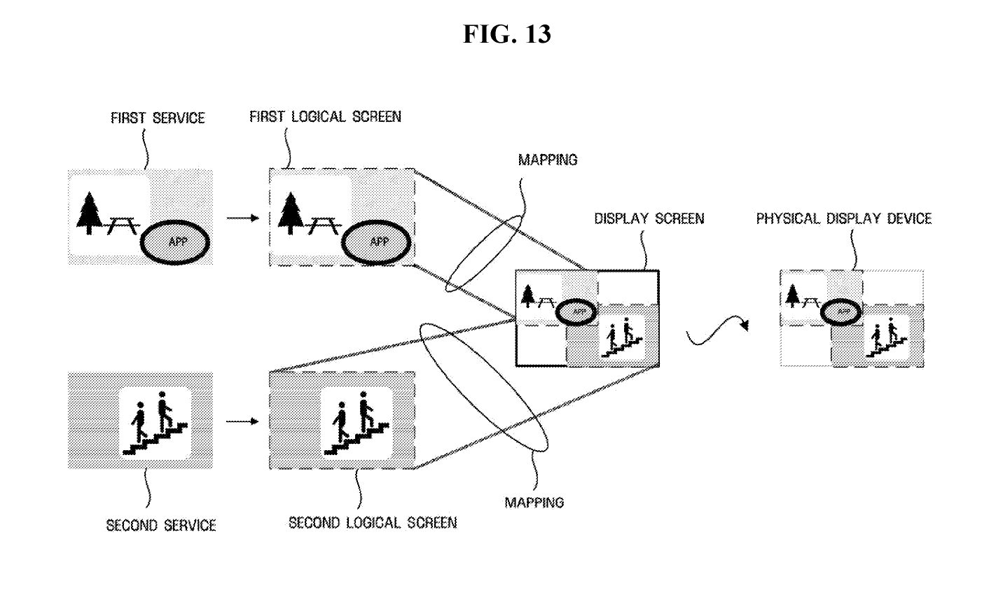

FIG. 14 is a diagram illustrating application regions according to an embodiment of the present invention. Referring to FIG. 14, first and second application regions 910 and 920 are arranged on a screen 900.

More specifically, referring to FIG. 14, one or more application regions, i.e., the first and second application regions 910 and 920, may exist on the screen 900. Each of the first and second application regions 910 and 920 displays an application.

An application may be connected to only one application region. For example, an application may be connected to only one of the first and second application regions 910 and 920. An application region may display one or more applications.

In a personal computer (PC) or workstation environment where a window manager exists, a frame consisting of a title and boundaries is managed by the window manager. However, it is difficult to manage such a frame in a system where no window manager exists.

An application region serves as a frame and can display an application without a requirement of a window manager. That is, an application can secure a certain region on a screen due to an application region.

An application region may be focused upon the request of a user or an application. An application region may be set in advance to be able to be focused upon the request of a user or an application. For example, an application region set to be able to be focused can be focused in response to a focus request command, whereas an application region set not to be able to be focused cannot be focused regardless of the focus request command.

Even if an application region is set to be able to be focused, the application region may not be able to be focused if a monitor application does not allow the focus of the application region.

An application region may be interpreted as an instance ‘HScene’ in a Java environment. Information regarding the instance ‘HScene’ may be managed by various methods included in a class object ‘HSceneManager’.

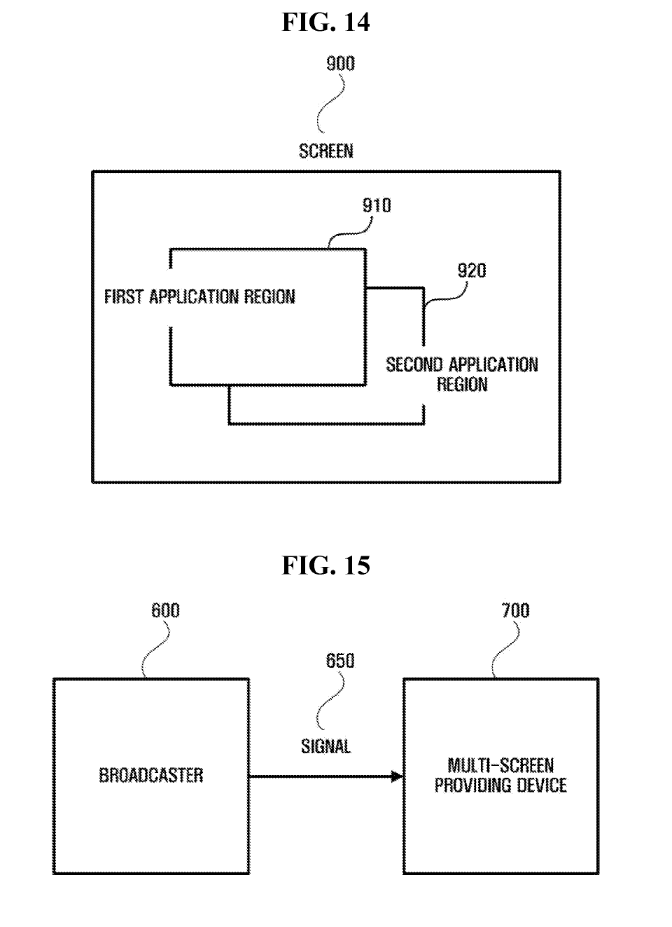

FIG. 15 is a diagram illustrating a configuration of a system providing multiple screens according to an exemplary embodiment of this invention. Referring to FIG. 15, the broadcaster 600 sends a signal to a multi-screen providing device 700 (e.g., an OCAP terminal).

In here, the broadcaster 600 sends a signal 650 including a flag indicating whether the multiple screens are supported while sending an application to the multi-screen providing device 700. Therefore, the multi-screen providing device 700 allocates an additional logical screen for the supplied application and provides the functions such as a size, a position of the logical screen, or pause, etc.

The application can be signaled through an XAIT transferred through an MPEG stream. In this case, the XAIT includes necessary information for creating contents of application data for the respective applications. For example, when receiving a new XAIT, the multi-screen providing device 700 can renew the application database using information signaled for the application associated to a service selected by a user.

In this case, the multi-screen providing device 700 varies the operations depending on the types of service, as follows:

a) when the application database does not have corresponding application in the application database, the multi-screen providing device 700 creates application information including information signaled by the XAIT;

b) even when the application data base has the corresponding application by the previous signaling, the signaling is no longer performed, the multi-screen providing device deletes the application from the application database;

c) when an application having the same version as in the application database is signaled, the multi-screen providing device 700 renew the application database on the basis of signaled application information;

d) when the application database includes an application, and a new application that is not related to active application instance is signaled, the multi-screen providing device 700 renews the application database on the basis of currently signaled application information; and

e) when the application database includes an application, and a new application that is related to active application instance is signaled, the multi-screen providing device 700 completes a signaling process for the previous application or creates application instance that permits only an application that is being executed.

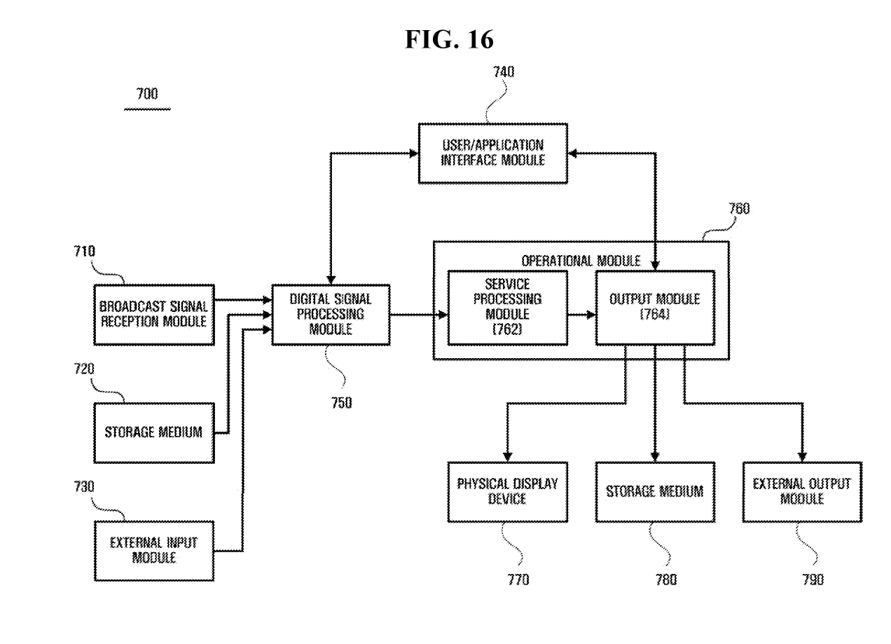

FIG. 16 is a block diagram of an apparatus for providing multiple screens according to an exemplary embodiment of the present invention.

Referring to FIG. 16, an apparatus 700 for providing multiple screens includes a digital signal processing module 750, a user/application interface module 740, and an operational module 760 which includes a service processing module 762 and an output module 764.

Also, the apparatus 700 includes a broadcast signal reception module 710, a storage medium 720, and an external input module 730 as service sources, and includes a physical display device 770, a storage medium 780, and an external output module 790 as service output media.

The term ‘module’, as used herein, means, but is not limited to, a software or hardware component, such as a Field Programmable Gate Array (FPGA) or an Application Specific Integrated Circuit (ASIC), which performs certain tasks. A module may advantageously be configured to reside on the addressable storage medium and configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

The digital signal processing module 750 receives various information of a service such as a multimedia content, e.g., video information, audio information, or data information, from the broadcast signal reception module 710, the storage medium 720, or the external input module 730.

The broadcast signal reception module 710 receives a satellite, terrestrial, or cable broadcast signal and transmits the received broadcast signal, the storage medium 720 stores video information, audio information, or data information of a service, and the external input module 730 receives video information, audio information, or data information of a service from an external device such as a network interface module connected to a network.

The digital signal processing module 750 restores a plurality of services using received service components. The restored services include abstract or non-abstract services.

Here, the phrase ‘a plurality of services’ refers to two or more services transmitted by the broadcast signal reception module 710 or two or more services respectively transmitted by the broadcast signal reception module 710 and the storage medium 720.

The digital signal processing module 750 may restore services according to selection by a user or an application with the aid of the user/application interface module 740. In this case, the user or the application may select the connection between an arbitrary service and a screen.

Further, the digital signal processing module 750 confirms whether the application included in data information is executed on a screen in respect to the received data information. In this case, the digital signal processing module 750 confirms a predetermined flag of the signal included in the data information and then confirm whether the execution is supported. The result is transmitted to the operation module 760 and the user/application interface module 740.

For example, when the flag is 1, a control signal (first control signal) indicating that the execution on the screen is supported is transmitted. Otherwise, when the flag is 0, a control signal (second control signal) indicating that the execution of the screen is not supported is transmitted.

The operation module 760 to which control signals have been transmitted varies the operations on the basis of the type of the control signal. When the first control signal is transmitted thereto, the operation module 760 operates the application on the screen. When the second control signal is transmitted thereto, the operation module 760 does not operate the application on the screen. In this case, the screen includes a Pip screen and a picture outside picture (PoP) screen.

The operation module 760 may map the logical screen to the display screen after operating the application on the logical screen, or directly operate the application on the display screen. For this purpose, the operation module 760 may include a service processing module 762 and an output module 764.

The service processing module 762 produces a logical screen and a display screen to display a service restored by the digital signal processing module 750. In this case, the logical screen may be a screen that is allocated for an application performed on a screen by being supported by signaling.

The output module 764 maps a plurality of logical screens produced by the service processing module 762 to the display screen. The mapping of the logical screens to the display screen may be conducted using a predefined method or a method set by the user with the aid of the user/application interface module 762. In detail, the user can perform of mapping for an application that supports multiscreens, in addition to video or audio

A service restored by the digital signal processing module 750 may not be connected to a logical screen produced by the service processing module 762, but directly connected to a display screen to be output by the output module 764.

A display screen provided by the output module 764 may be displayed on the physical display device 970 or may be stored in the storage medium 780. Examples of the storage medium 780 include computer readable floppy discs, hard discs, CD-ROM. DVD, DVD-ROM, BD (Blu-ray Disc), and semiconductor memories.

Also, a display screen provided by the output module 764 may be transmitted to an external device connected to a network via the external output module 790.

For this, the output module 764 may include a plurality of output ports via which a display screen can be provided. In this case, a display screen can be provided via an output port set in advance as a default or an output port chosen by the user with the aid of the user/application interface module 740.

The user or the application can choose one of a plurality of services or restore desired services using the user/application interface module 740. Also, the user can choose one of a plurality of display screens using the user/application interface module 740.

As described above, each application region may be set to be able to be focused by a user or an application. The digital signal processing module 750 may determine whether an application region on a screen where an application is displayed can be focused by referencing predetermined information regarding the application region, for example, a flag.

Then, the digital signal processing module 750 transmits a control signal indicating whether the application region can be focused to the operational module 760. The operational module 760 operates an application in the application region in response to the control signal transmitted by the digital signal processing module 750. The operational module 760 may decide whether to focus the application region according to whether a focus allow command has been received and according to whether the application region can be focused.

That is, the user/application interface module 740 receives a focus request command regarding the application region from a user or an application. Then, the digital signal processing module 750 issues a focus request regarding the application region to a monitor application in response to the focus request command received by the user/application interface module 740.

In order to issue the focus request, the digital signal processing module 750 may call a method ‘requestHSceneFocus’. The method ‘requestHSceneFocus’ is used to issue a request for the focus of a certain application region (e.g., ‘HScene’). The method ‘requestHSceneFocus’ has an instance ‘HSceneBinding’ as a parameter. A monitor application can identify an application region to be focused by referencing the instance ‘HSCeneBinding’ of the method ‘requestHSceneFocus’.

A monitor application may decide whether to focus an application region by referencing graphic resources and memory resources currently being used by the multi-screen providing device 700. If the monitor application allows the focus of an application region, the monitor application transmits a focus allow command to the operational module 760. Then, the operational module 760 focuses the application region, i.e., disposes the application region on an uppermost layer on a screen, in response to the focus allow command. Once the focus of the application region is allowed by the monitor application, a focus allow event occurs. The focus allow event is transmitted to one or more applications currently being executed in the multi-screen providing device 700.

The operational module 760 may determine whether an application region is set to be able to be focused before the focus of the application region. More specifically, if an application region is set to be able to be focused, the operational module 760 may dispose the application region on an uppermost layer on a screen. On the other hand, if the application region is set not to be able to be focused, the operation module 760 may not focus the application region.

In order to focus an application region, the operational module 760 may call a method ‘focusChanged’. The method ‘focuschanged’ has, as parameters, an instance ‘HSceneBinding’ which is connected to an application region currently being focused and an instance ‘HSCeneBinding’ which is connected to an application region to be focused. That is, when the method ‘focusChanged’ is called, the focus of the application region currently being focused is terminated, and then, the application region to be focused begins to be focused.

A null value may be input as a parameter of the method ‘requestHSceneFocus’. In this case, it appears that there is no application region to be focused. Therefore, an application region currently being focused loses its focus, and no other application region is focused. That is, when a method ‘requestHSceneFocus’ having a null value as a parameter is called, there is no application region currently being focused on a screen.

Since the modules illustrated in FIG. 16 are divided according to their functions, it is possible to be connected to the other modules.

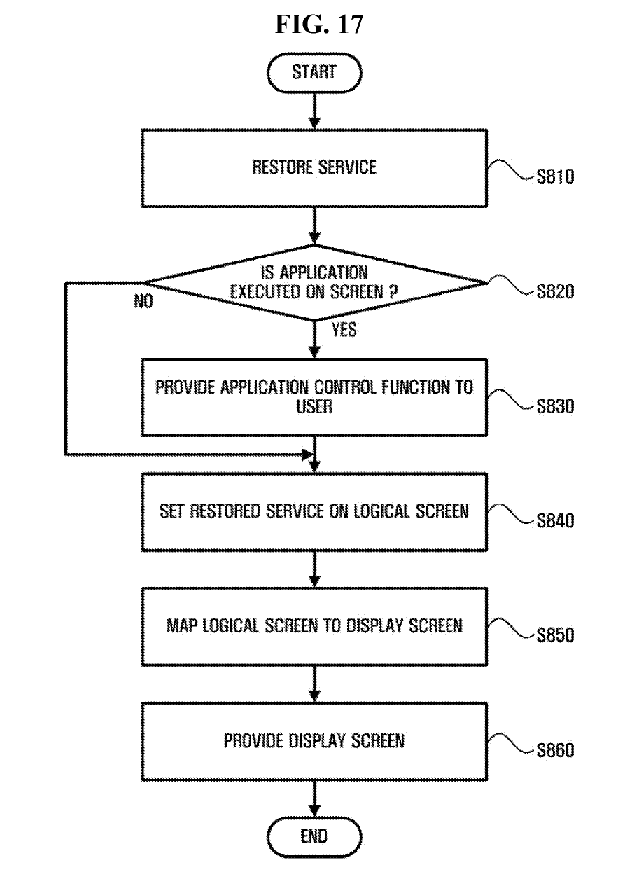

FIG. 17 is a flowchart illustrating a method of dynamically configuring multiple screens according to an exemplary embodiment of the present invention.

In general, video information, audio information, and data information constituting a multimedia content are transmitted in a predetermined format, for example, an MPEG stream format. In operation S810, an apparatus for providing a service such as a multimedia content service receives video information, audio information, and data information and restores a service based on the video information, the audio information, and the data information. Here, the service restored in operation S810 may be selected or previously determined by a user or an application. The user may use a menu displayed on the display device 770 or a remote controller to select the connections between an arbitrary screen and a screen. The application may select the connections using an API.

In operation S820, the multi-screen providing device 700 confirms that the application included in the data information is executed on the screen on the basis of the received data information while receiving the multimedia contents.

The confirmed result is output through the user/application interface module 740. In operation 830, when a signal included in the data information includes a flag that the multi-screen is supported, the user/application interface module 740 can provide a control function for the application (for example, allocation of the logical screen and control of the screen size) to a user.

Further, the multi-screen providing device 700 manages the lifecycle of the application using a signal 650 that is continuously received. When the signal is not received, the multi-screen providing device 700 completes the application.

In operation S840, the multi-screen providing device 700 sets the restored service to be displayed on the logical screen according to the exemplary embodiment after confirming the signaling. Further, the logical screen is mapped to a display screen according to the exemplary embodiment in operation S850, and the display screen is provided in operation S860. In this case, the user can allocate the supplied application to a logical screen and input the size and position of the screen. Therefore, the multi-screen providing device 700 can map the logical screen to the display screen according to the input content by the user.

The restored service is illustrated in FIG. 17 as being displayed on a physical display device via a logical screen. However, the restored service may be directly displayed on a physical display device without passing through the logical screen.

When the user selects the PiP service, the PiP service is realized in two modes. In the first mode, only video component for PiP service selected on the main screen is provided without creating a separate logical screen for PiP service, that is, PiP screen. In the second mode, a separate logical screen for PiP service is created to provide the PiP service selected on the created PiP screen.

FIG. 17 illustrates a method of mapping only one service to a display screen for simplicity. However, a plurality of services may be mapped to a display screen with or without passing through a plurality of logical screens.

When a physical display device 770 is provided to the user in this manner, the user can perform a plurality of services.

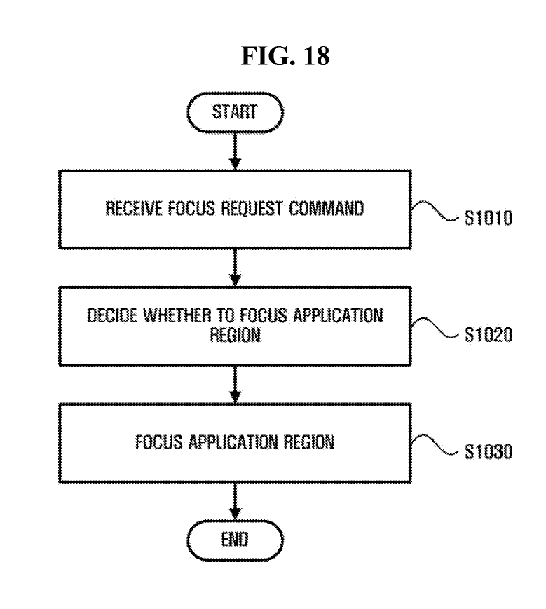

FIG. 18 is a flowchart illustrating the focus of an application region according to an embodiment of the present invention. Referring to FIG. 18, in operation S1010, the user/application interface module 740 receives a focus request command regarding whether to focus an application region from a user or an application.

The digital signal processing module 750 transmits the focus request command to a monitor application.

In operation S1020, the monitor application decides whether to focus the application region by referencing resources currently being used by the multi-screen providing device 700.

In operation S1030, if the monitor application allows the focus of the application in operation S1020, a focus allow command is transmitted to the operational module 760, and the operational module 760 focuses the application region.

The operation module 760 may determine whether the application region can be focused before the focus of the application region.

According to the exemplary embodiments of the present invention, a user or an application can focus or terminate the focus the application region by controlling the focus of a selected region after receiving a focus request regarding a region displaying the application on the screen.

While the present invention has been particularly illustrated and described with reference to exemplary embodiments thereof, it will be understood by those of ordinary skill in the art that various changes in form and details may be made therein without departing from the spirit and scope of the present invention as defined by the following claims. Therefore, it is to be understood that the above-described exemplary embodiments have been provided only in a descriptive sense and will not be construed as placing any limitation on the scope of the invention.

What is claimed is:

1. An apparatus for providing multiple screens, the apparatus comprising:
a digital signal processing module which confirms whether a focus request regarding a first region on a screen has been issued, the first region displaying an application included in received data information; and
an operational module which operates the application on the screen based on a confirmation result output by the digital signal processing module.

2. The apparatus of claim 1, wherein the first region includes at least one of a plurality of regions that represent a plurality of applications, respectively.

3. The apparatus of claim 1, further comprising an interface module which receives a control command including the focus request.

4. The apparatus of claim 1, wherein, if a focus allow command is received in response to the focus request, the operational module disposes the first region on an uppermost layer of the screen.

5. The apparatus of claim 1, wherein, if a focus allow command is not received in response to the focus request, the operational module prevents the first region from being focused on the screen.

6. A method of providing multiple screens, the method comprising:
confirming whether a focus request regarding a first region on a screen has been issued, the first region displaying an application included in received data information; and
operating the application on the screen based on a result of the confirming.

7. The method of claim 6, wherein the first region includes at least one of a plurality of regions that represent a plurality of applications, respectively.

8. The method of claim 6, further comprising receiving a control command including the focus request.

9. The method of claim 6, wherein the operating comprises disposing the first region on an uppermost layer of the screen if a focus allow command is received in response to the focus request.

10. The method of claim 6, wherein the operating comprises preventing the first region from being focused on the screen if a focus allow command is not received in response to the focus request.
